(19) United States
(12) Patent Application Publication
(10) Pub. No.: US 2025/0282545 A1
(43) Pub. Date: Sep. 11, 2025

(54) CONTAINER-HANDLING SYSTEM

(71) Applicant: Ocado Innovation Limited, Hatfield (GB)

(72) Inventors: Daniel CLARK, Hatfield (GB); Alan RUFFELL, Hatfield (GB); Malte GRUBER, Stockholm (SE)

(21) Appl. No.: 19/217,396

(22) Filed: May 23, 2025

Related U.S. Application Data
(63) Continuation of application No. PCT/EP2023/083154, filed on Nov. 27, 2023.

(30) Foreign Application Priority Data
Nov. 28, 2022 (GB) 2217791.9

(51) Int. Cl. B65G 1/02; B65G 1/04; B65G 43/08

(52) U.S. Cl. CPC B65G 1/026; B65G 1/0464; B65G 1/0478; B65G 43/08; B65G 2201/0235; B65G 2203/0283; B65G 2203/041

(57) ABSTRACT

A load handling device is provided for lifting and moving storage containers arranged in stacks in a storage structure, the storage structure comprising a track structure above the stacks of storage containers. The load handling device comprises a body, a driving assembly configured to move the body on the track structure, and a container-handling system. The container-handling system comprises: a holding frame; a holding assembly mounted on the holding frame, wherein the holding assembly is configured to releasably hold a storage container in a holding region with respect to the holding frame; a lifting assembly configured to lower and raise the holding frame relative to the body; and an overheight detection system comprising object detection means mounted on the holding frame, wherein the object detection means is configured to detect the presence of an object in an overheight region, wherein the overheight region is above the holding region.

### CROSS-REFERENCE TO RELATED APPLICATIONS

This Application is a continuation of PCT International Patent Application No. PCT/EP2023/083154, filed on Nov. 27, 2023, which claims priority to UK Patent Application No. GB2217791.9, filed on Nov. 28, 2022, the entire contents of which are hereby incorporated by reference.

### TECHNICAL FIELD

The present invention relates to devices for handling storage containers in a storage and retrieval system.

### BACKGROUND

Some commercial and industrial activities require systems that enable the storage and retrieval of a large number of different products. WO2015019055A1 describes a storage and retrieval system in which items are stored in storage containers and the storage containers are arranged in stacks within a grid storage structure. The system further comprises remotely operated load handling devices configured to move on tracks located on the top of the grid storage structure. To pick up or drop off storage containers stored in the grid storage structure, each load handling device is equipped with a gripper device for releasably holding a storage container, and a lifting assembly for raising and lowering the gripper device.

Objects that have not been loaded in an expected manner into the storage containers can cause problems within the storage and retrieval system. For example, a situation may occur in which an object protrudes above the top of a storage container. A protruding item can cause a number of issues, such as preventing the gripper device from engaging properly with the storage container and preventing the storage container from being properly received by the load handling device, as well as downstream issues such as the storage container becoming stuck in another region of the storage and retrieval system.

The present invention aims to address the problem of storage containers containing protruding items within a storage and retrieval system.

### SUMMARY

The invention is defined in the accompanying claims.

The invention provides a container-handling system comprising: a holding frame; a holding assembly mounted on the holding frame, wherein the holding assembly is configured to releasably hold a storage container in a holding region with respect to the holding frame; and an overheight detection system comprising object detection means mounted on the holding frame, wherein the object detection means is configured to detect the presence of an object in an overheight region, wherein the overheight region is above the holding region.

The overheight region may be substantially planar. The overheight region may be a substantially horizontal plane. This helps to minimize the chance of erroneously detecting an object within the holding region (i.e. within the storage container). The object detection means may be configured to detect the presence of an object between at least two points lying in the horizontal plane. The overheight region may be at a fixed position with respect to the holding frame. The object detection means may be configured to detect an object extending from the holding region into or through the overheight region.

The holding region may be at a fixed position with respect to the holding frame. The holding assembly may be configured to releasably hold a storage container from above. The holding region may be below the holding frame. The holding frame and the holding assembly may be configured so as to define an upper limit of the holding region. In other words, the holding frame and the holding assembly may be configured such that a storage container being held by the holding assembly cannot move upwardly relative to the holding frame past the upper limit due to being physically blocked by a component of the holding frame. The holding frame may comprise one or more frame members arranged in a substantially horizontal plane. The holding frame may have a rectangular shape. The holding region may be below the frame members. An upper limit for the holding region may be the bottom-most surface of the frame members. The overheight region may be above the bottom-most surface of the frame members.

The holding frame may comprise a frame opening extending vertically through the holding frame. At least a portion of the overheight region may be located within the frame opening. The overheight region may be fully within the frame opening. At least a portion of the overheight region may be located above the frame opening. The overheight region may be fully above the frame opening. At least a portion of the object detection means may be mounted within the holding frame opening. At least a portion of the object detection means may be mounted above the frame opening. The object detection means may be configured to detect an object extending from the holding region into or through the frame opening.

The object detection means may comprise a sensor assembly arranged on opposing lateral sides of the overheight region. In the case where the holding frame comprising a frame opening, the sensor assembly may be arranged on opposing lateral sides of the frame opening. The sensor assembly may comprise one or more photoelectric sensors. The sensor assembly may comprise a through-beam sensor arrangement. The sensor assembly may comprise a retroreflective sensor arrangement.

The sensor assembly may comprise at least one transmitter and at least one receiver mounted on the holding frame on opposing lateral sides of the overheight region. The at least one transmitter may be configured to emit a signal towards the at least one receiver. The at least one receiver may be configured to detect the signal from the at least one transmitter. The overheight detection system may further comprise a controller communicably coupled to the at least one transmitter and the at least one receiver. The controller may be configured to determine that an object is in the overheight region when the signal between the at least one transmitter and the at least one receiver is interrupted.

The sensor assembly may comprise at least one transmitter and at least one receiver mounted on the holding frame on the same lateral side of the overheight region, and at least one reflector at an opposing lateral side of the overheight region. The at least one transmitter is configured to emit a signal towards the at least one reflector and the at least one receiver is configured to detect the signal from the at least one transmitter after being reflected by the at least one reflector. The overheight detection system may further comprise a controller communicably coupled to the at least one transmitter and the at least one receiver. The controller may be configured to determine that an object is in the overheight region when the signal between the at least one transmitter and the at least one receiver via the at least one reflector is interrupted.

The object detection means may comprise a camera mounted on the holding frame. The camera may be configured to capture an image containing the overheight region. The object detection means may further comprise one or more processors configured to analyze the image and determine the presence of an object within the overheight region.

The object detection means may comprise a substantially horizontal sheet defining the overheight region. The object detection means may be configured to detect a force being applied to the horizontal sheet to determine the presence of an object in the overheight region. The object detection means may comprise a mechanical force sensor.

The container-handling system may further comprise a lifting assembly configured to lower and raise the holding frame.

The lifting assembly may comprise at least one tether and at least one motor or other winding and unwinding means. The at least one tether may be (directly or indirectly) coupled between the holding frame and the at least one motor. The at least one motor may be configured to wind and unwind the at least one tether to raise and lower the holding frame respectively.

The container-handling system may further comprise a control system comprising one or more controllers configured to control operation of the holding assembly based on a detection outcome by the object detection means. The control system may be configured such that the holding assembly is not activated if the object detection means detects the presence of an object in the overheight region.

In the case where the container-handling system comprises the lifting assembly, the control system may be configured to activate the overheight detection system (i.e. activate the object detection means) when the lifting assembly is lowering the holding frame, or once the lifting assembly has lowered the holding frame to a predetermined position.

In the case where the container-handling system comprises the lifting assembly, the control system may be configured to control the lifting assembly to raise the holding frame without activating the holding assembly if the object detection means detects the presence of an object in the overheight region.

The overheight detection system may be configured to determine the height of an object protruding above a storage container based on a vertical distance descended by the holding frame during a time period between the point at which an object is first detected in the overheight region and the point at which a storage container is in the holding region.

The holding assembly may comprise a plurality of grippers mounted on the holding frame. Each gripper may be movable between an engaged position and a disengaged position for engaging and disengaging the storage container respectively.

The present invention also provides a load handling device for lifting and moving storage containers arranged in stacks in a storage structure, the storage structure comprising a track structure above the stacks of storage containers. The load handling device may comprise: a body; a driving assembly configured to move the body on the track structure; and the container-handling system having a lifting assembly as defined above, wherein the lifting assembly is configured to lower and raise the holding frame relative to the body.

The load handling device may further comprise a container-receiving space configured to accommodate a storage container held by the holding frame. The lifting assembly may be configured to raise and lower the holding frame into and out of the container-receiving space respectively.

The track structure may be a track structure comprises a first set of tracks and a second set of tracks, the first set of tracks extending in a first direction and the second set of tracks extending in a second direction, the second direction being substantially perpendicular to the first direction, to form a grid pattern defining a plurality of grid cells. The driving assembly may be configured to move the body of the load handling device on this track structure.

The present invention also provides a storage and retrieval system comprising: a storage structure comprising: a plurality of stacks of storage containers, each storage container having a top opening through which objects can be placed into the storage container; and a track structure arranged above the stacks of storage containers and configured to allow access to each stack from above, the storage and retrieval system further comprising at least one load handling device as defined above, wherein the container-handling system is configured to pick up and drop off storage containers from and onto the stacks of storage containers.

The track structure may comprise a first set of tracks and a second set of tracks. The first set of tracks may extend in a first direction and the second set of tracks extending in a second direction, the second direction being substantially perpendicular to the first direction, to form a grid pattern defining a plurality of grid cells. Each stack of storage containers may be arranged below a grid cell.

The storage and retrieval according may further comprise a central control system configured to communicate with the at least one load handling device. The central control system may be configured to command the load handling device to move to a target grid cell from a list of available grid cells to pick up or drop off a storage container below the target grid cell. The central control system may be further configured to remove the target grid cell from the list of available grid cells if the overheight detection system detects an object in the overheight region when the load handling device is at the target grid cell.

The present invention also provides a method of using the container-handling system defined above. The method comprises the steps of: lowering the holding frame towards a storage container; detecting whether or not an object is present within the overheight region; if an object is detected, raising the holding frame away from the storage container without activating the holding assembly; and if an object is not detected, activating the holding assembly to hold the storage container and then raising the holding frame.

### DESCRIPTION OF THE DRAWINGS

The present invention will now be described, by way of example only, with reference to the accompanying drawings, in which like reference numerals are used for like features, and in which:

FIG. 1 is a schematic perspective view of a grid storage structure and containers arranged within the grid storage structure.

FIG. 2 is a schematic plan view of a track structure on top of the storage structure of FIG. 1.

FIG. 3 shows load handling devices on top of the track structure of the storage structure of FIG. 1.

FIG. 4 is a schematic perspective view of a load handling device with a holding frame in a position below the bottom of the load handling device.

FIG. 5 is a schematic perspective view of the load handling device of FIG. 4 with a side panel removed to show a container-receiving space.

FIG. 6 is a schematic perspective view of the load handling device of FIG. 5 with a container occupying the container-receiving space.

FIG. 7 is a perspective view of a container-handling system comprising a lifting assembly and a holding frame.

FIG. 8A is a front perspective view of a gripper assembly in a closed configuration. FIG. 8B is a front perspective view of a gripper assembly in an open configuration.

FIG. 9A is a rear perspective view of the gripper assembly in a closed configuration, as in FIG. 8A. FIG. 9B is a rear perspective view of the gripper assembly in an open configuration, as in FIG. 8B.

FIG. 10 is a perspective view of a storage container that may be held by the holding frame of the container-handling system.

FIG. 11A is a side view of the holding frame and the storage container with the gripper assembly disengaged with the storage container. FIG. 11B is a side view of the holding frame and the storage container with the gripper assembly engaged with the storage container.

FIG. 12 is a perspective view of the holding frame holding the storage container.

FIG. 13 is a schematic perspective view of the holding frame holding the storage container and an example object detection means of the container-handling system.

FIG. 14 is a schematic cross-sectional view of the example of FIG. 13 with an overheight object in the storage container.

FIG. 15 is a schematic perspective view of the holding frame holding the storage container and another example object detection means of the container-handling system.

FIG. 16 is a schematic perspective view of the holding frame holding the storage container and another example object detection means of the container-handling system.

FIG. 17 is a schematic bottom perspective view of an alternative holding frame of the container-handling system.

FIG. 18 is a block diagram of a control system.

### DETAILED DESCRIPTION

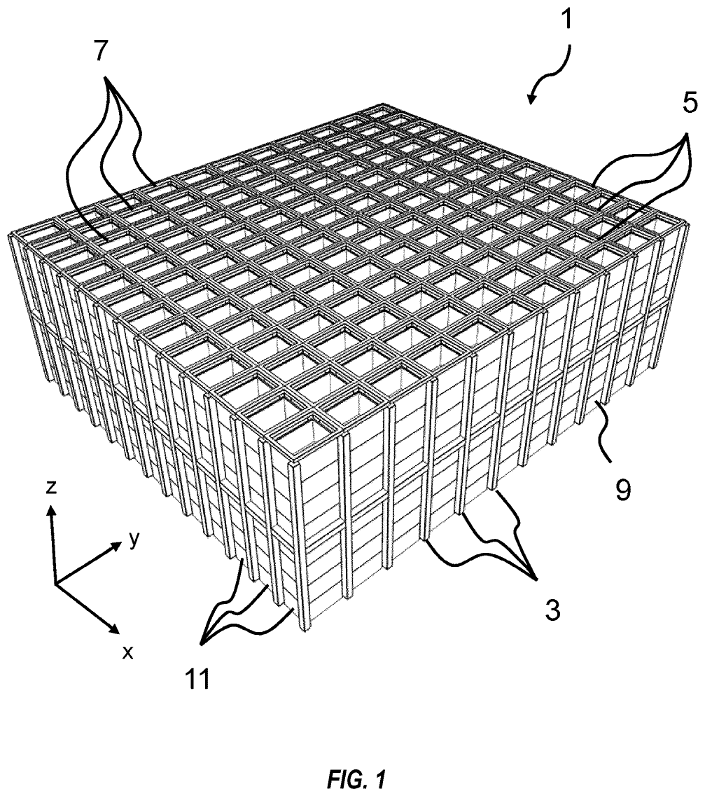

FIG. 1 illustrates an example storage structure 1 that may be used in a storage and retrieval system to store storage containers 50. The storage structure 1 comprises a holding framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 50 are arranged in stacks 11 beneath the grid cells 14 defined by the grid pattern, one stack 11 of storage containers 50 per grid cell 14.

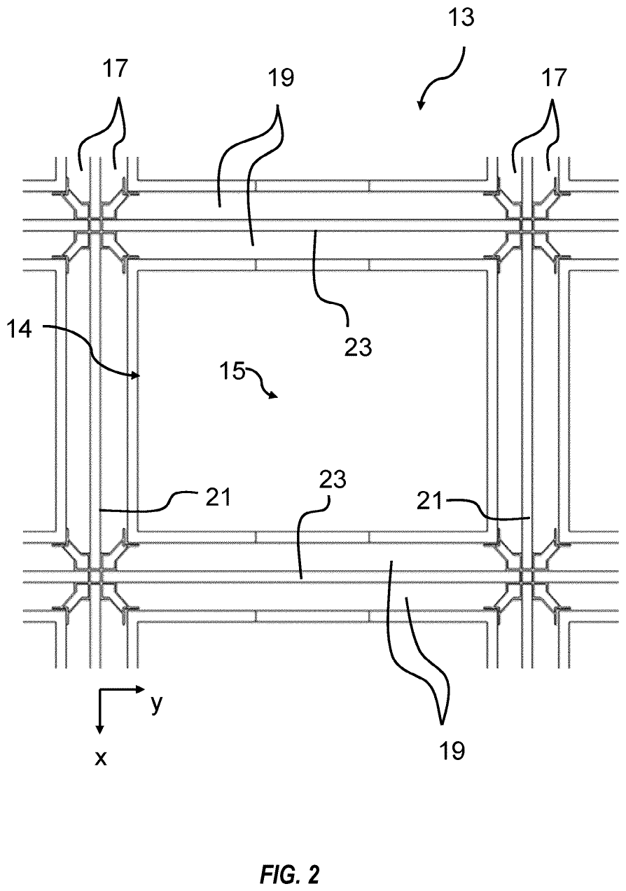

FIG. 2 shows a large-scale plan view of a section of track structure 13 forming part of the storage structure 1 illustrated in FIG. 21 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centers of the grid cells 14. The apertures 15 are sized to allow storage containers 50 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

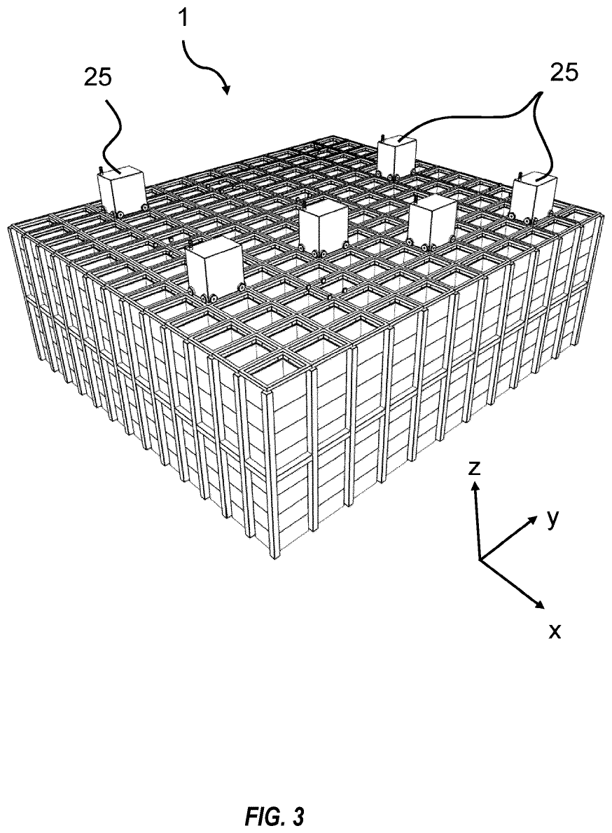

FIG. 3 shows a plurality of load handling devices 25 moving on top of the storage structure 1 illustrated in FIG. 1. The load handling devices 25, hereinafter referred to as “bots”, are provided with sets of wheels to engage with corresponding x-or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighboring grid cells 14 without colliding with one another.

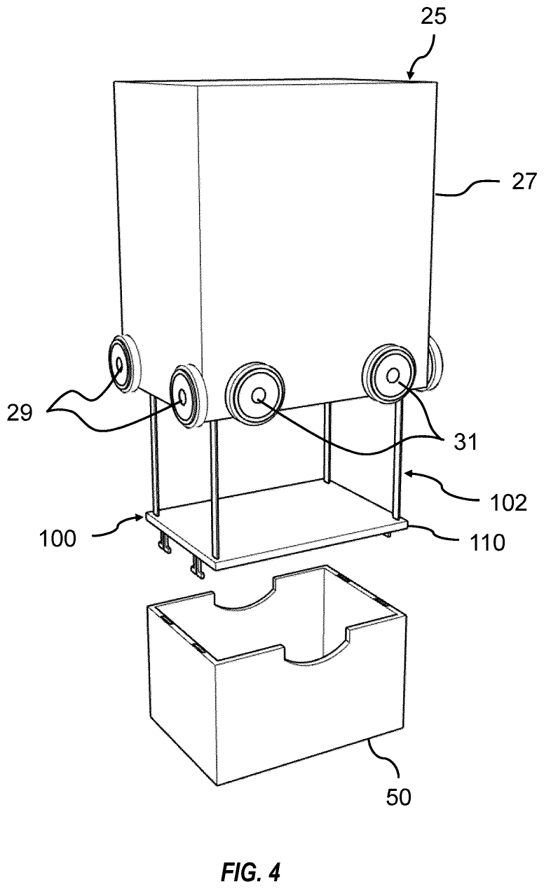

As illustrated in FIG. 4, a bot 25 comprises a body 27 in or on which are mounted one or more components which enable the bot 25 to perform its intended functions. These functions may include moving across the storage structure 1 on the track structure 13 and raising or lowering storage containers 50 (e.g. from or to stacks 11) so that the bot 25 can retrieve or deposit storage containers 50 in specific locations defined by the grid pattern.

The illustrated bot 25 comprises a driving assembly comprising first and second sets of wheels 29, 31 which are mounted on the body 27 of the bot 25 and enable the bot 25 to move in the x-and y-directions along the tracks 17 and 19, respectively. In particular, two wheels 29 are provided on the shorter side of the bot 25 visible in FIG. 4, and a further two wheels 29 are provided on the opposite shorter side of the bot 25. The wheels 29 engage with tracks 17 and are rotatably mounted on the body 27 of the bot 25 to allow the bot 25 to move along the tracks 17. Analogously, two wheels 31 are provided on the longer side of the bot 25 visible in FIG. 4, and a further two wheels 31 are provided on the opposite longer side of the bot 25. The wheels 31 engage with tracks 19 and are rotatably mounted on the body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the body 27, thereby enabling the load handling device 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 27 of the bot 25 stays substantially at the same height and therefore the weight of the body 27 and the components mounted thereon does not need to be lifted and lowered by the wheel-positioning mechanism.

FIG. 4 also schematically shows a container-handling system 100 for holding and transporting storage containers 50 between different locations in the storage structure 1. The container-handling system 100 comprises a holding frame 110 for releasably holding storage containers 50 and a lifting assembly 102 coupled to the holding frame 110 and configured to lower and raise the holding frame 110 relative to the body 27 of the bot 25. Further details of the container-handling system 100 will be described later.

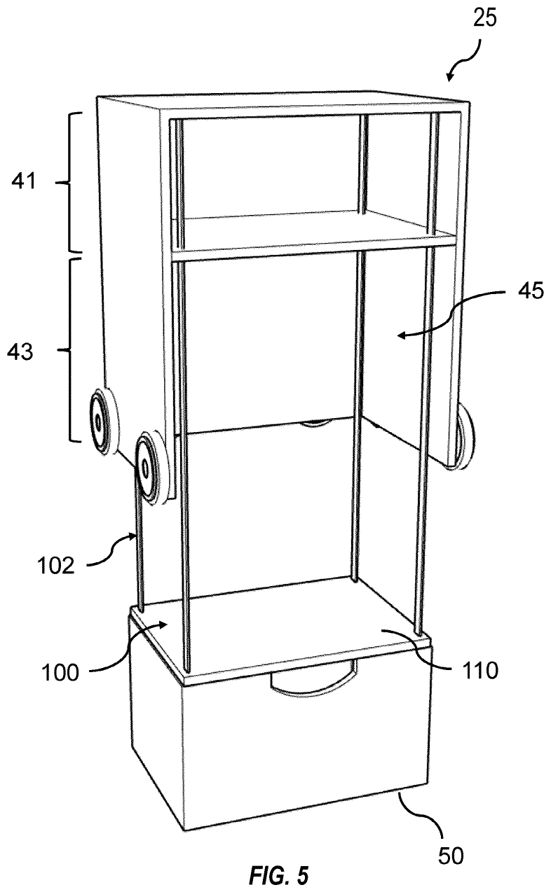

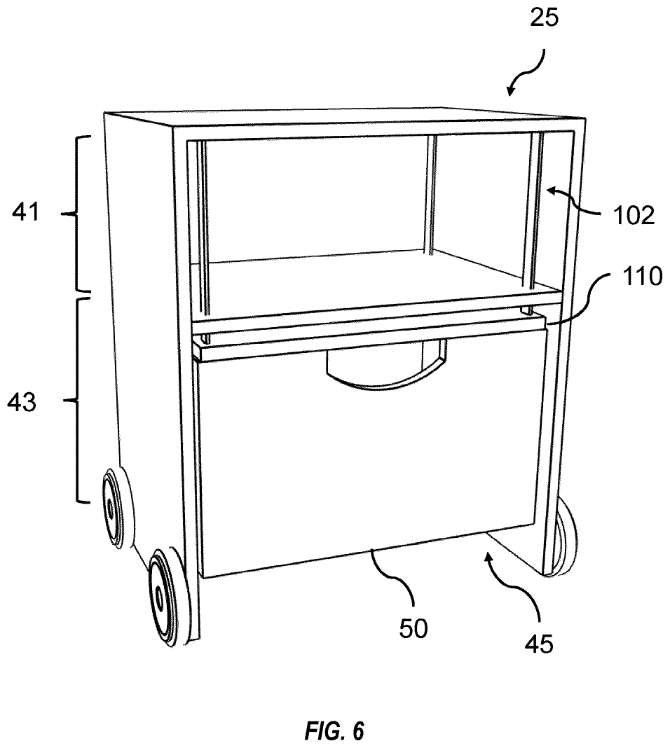

In FIG. 5 and FIG. 6, a side panel of the bot 25 has been omitted from view to allow the interior of the bot 25 to be seen. The body 27 of the illustrated bot 25 has an upper portion 41 and a lower portion 43. The upper portion 41 is configured to house or support one or more operation components (not shown), such as components of the lifting assembly 102 (e.g. motors), wireless communication components, one or more processors for controlling operation of the bot 25, etc. The lower portion 43 is arranged beneath the upper portion 41. The lower portion 43 is externally open at the bottom and defines a container-receiving space 45 for accommodating at least part of a storage container 50 that has been raised into the container-receiving space 45 by the holding frame 110 and lifting assembly 102. FIG. 5 shows the container-receiving space 45 before it is occupied by a storage container 50 and FIG. 6 shows the container-receiving space 45 after it has been occupied by a storage container 50. The container-receiving space 45 is sized such that enough of a storage container 50 can fit inside the space 45 to enable the bot 25 to move across the track structure 13 on top of storage structure 1 without the underside of the storage container 50 catching on the track structure 13 or another part of the storage structure 1. When the bot 25 has reached its intended destination, the lifting assembly 102 lowers the holding frame 110 and the corresponding storage container 50 out of the container-receiving space 45 and into the intended position. The intended position may be a stack 11 of storage containers 50 or an egress point of the storage structure 1 (or an ingress point of the storage structure 1 if the bot 25 has moved to collect a storage container 50 for storage in the storage structure 1). Although in the illustrated example the upper and lower portions 41, 43 are separated by a physical divider, in other examples, the upper and lower portions 41, 43 may not be physically divided by a specific component or part of the body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the body 27 of the bot 25. For example, the container-receiving space 45 may instead be adjacent to the body 27 of the bot 25, e.g. in a cantilever arrangement with the weight of the body 27 of the bot 25 counterbalancing the weight of the container 50 to be lifted. In such embodiments, a supporting structure of the lifting assembly 102 may protrude horizontally from the body 27 of the bot 25, and lifting assembly 102 may be configured to lower and raise the holding frame 110 relative to the supporting structure to lower and raise a storage container 50 into the container-receiving space 45 adjacent to the body 27.

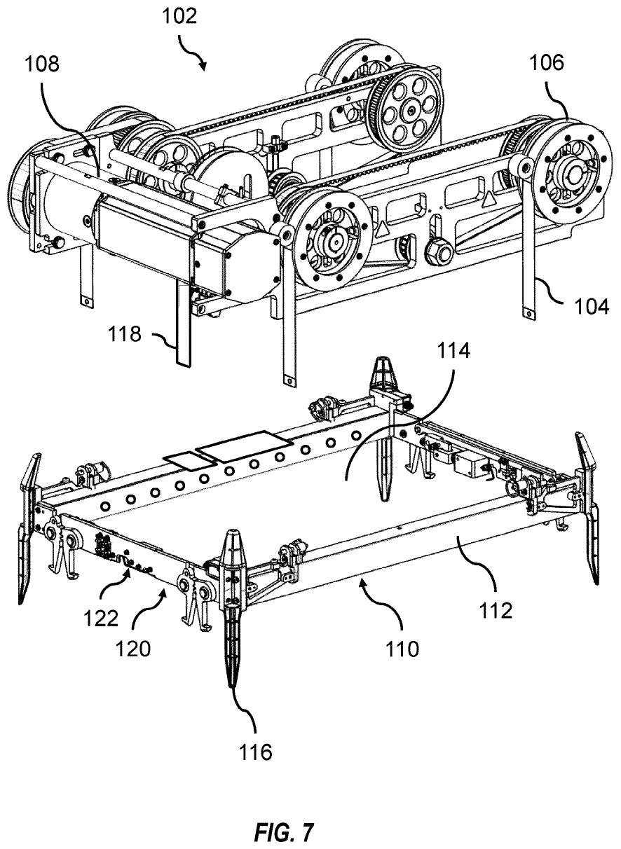

FIG. 7 shows an example container-handling system 100 for use with the bot 25. The container-handling system 100 comprises a holding frame 110 and a lifting assembly 102.

The lifting assembly comprises four tethers 104 which are connected at their upper ends to respective spools 106 and at their lower ends to the holding frame 110 (though FIG. 7 shows the tethers 104 disconnected from the holding frame 110. The tethers 104 may be in the form of cables, ropes, tapes, or any other form of tether with the necessary physical properties to lift the storage containers 50. The tethers 104 can be wound up or down to raise or lower the holding frame 110 as required. One or more motors 108 or other winding and unwinding means is provided to effect or control rotation of the spools 106 to wind the tethers 104 up or down. The container-handling system 100 is not limited to the particular lifting assembly shown in FIG. 7 and other arrangements suitable for raising and lowering the holding frame 110 may be used.

The holding frame 110 is in the form of an open rectangular frame. In particular, the holding frame comprises four elongate frame members 112 arranged to form a rectangular frame defining a central rectangular frame opening 114. In use, the holding frame 110 is orientated such that the frame members 112 lie in a substantially horizontal plane with the frame opening 114 extending vertically through the holding frame 110.

The holding frame further comprises a holding assembly 120 configured to engage with engagement features of the storage containers 50 to releasably hold the containers 50 from above. In this example, the holding assembly 120 comprises two gripper assemblies 122 mounted on two frame members 112 at opposing ends of the holding frame 120.

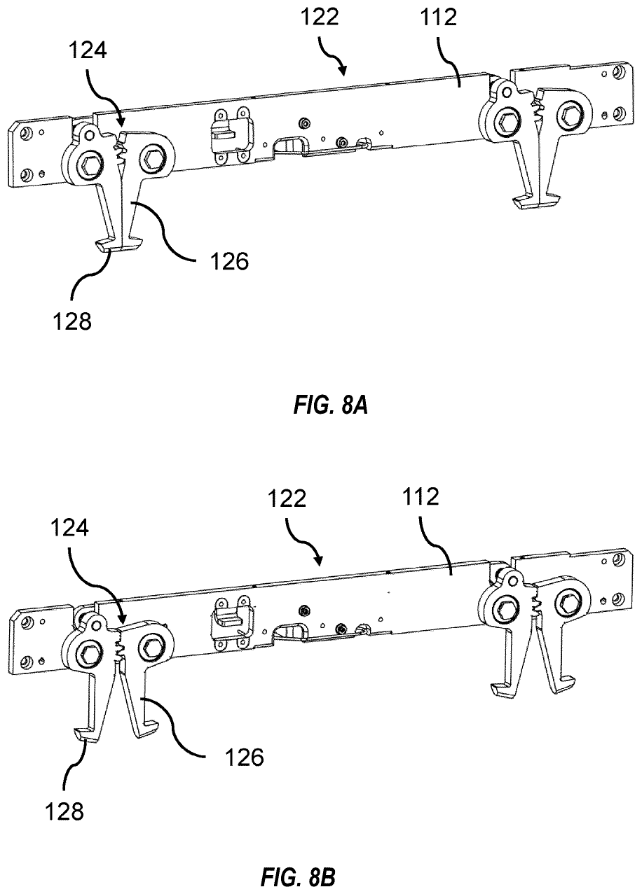

FIGS. 8A-8B show a front view of a gripper assembly 122 in isolation. The gripper assembly 122 comprises two grippers 124. Each gripper 124 comprises a pair of legs 126. Each leg 126 is pivotally mounted at one end on the frame member 112 for rotational movement in a vertical plane, and each leg 126 comprises a foot 128 at the other end. The legs 126 extend below the frame member 112 such that the feet 128 are located below the frame member 112. Each pair of legs 126 is rotatable between a closed position (FIG. 8A) in which the feet 128 are close together and an open position in which the feet 128 further apart (FIG. 8B).

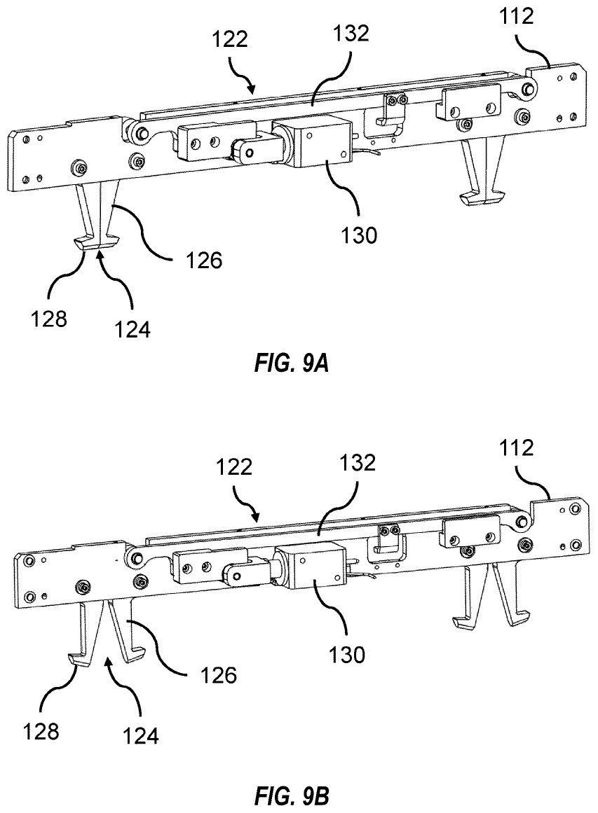

FIGS. 9A-9B show the gripping assembly 122 from the rear when the grippers 124 are in the closed position and the open position respectively. The pairs of legs 126 are driven between the closed position and the open position by a linear actuator 130 and a linkage assembly 132 coupled between the linear actuator and each pair of legs 126.

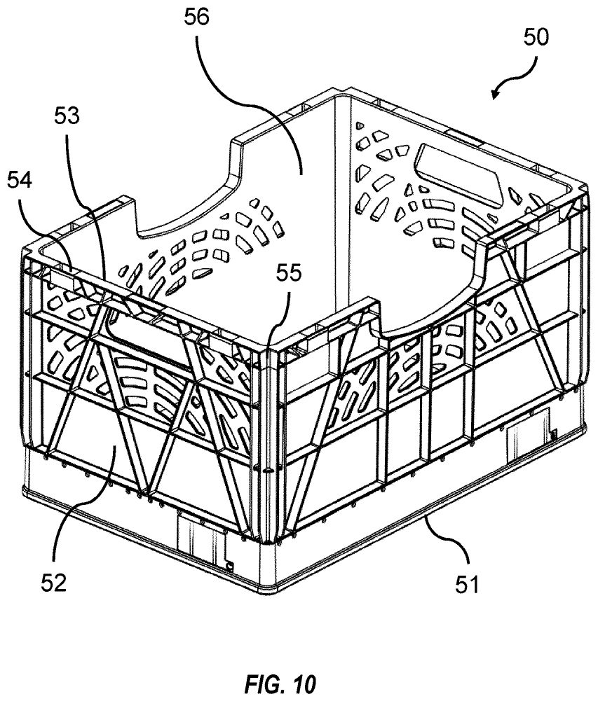

FIG. 10 shows an example storage container 50 that can be held by the holding frame 110. The storage container 50 comprises a base 51 and sidewalls 52 extending upwards from the base 51 to form a cuboidal storage container with a top opening 56 through which objects can be placed into or removed from the storage container 50. The storage container 50 further comprises a rim 53 at the top of the sidewalls 52. The rim 53 comprises engagement features 54 for engaging with the grippers 124 of the holding frame 120. In this example, the engagement features 54 are apertures extending vertically through the rim 53.

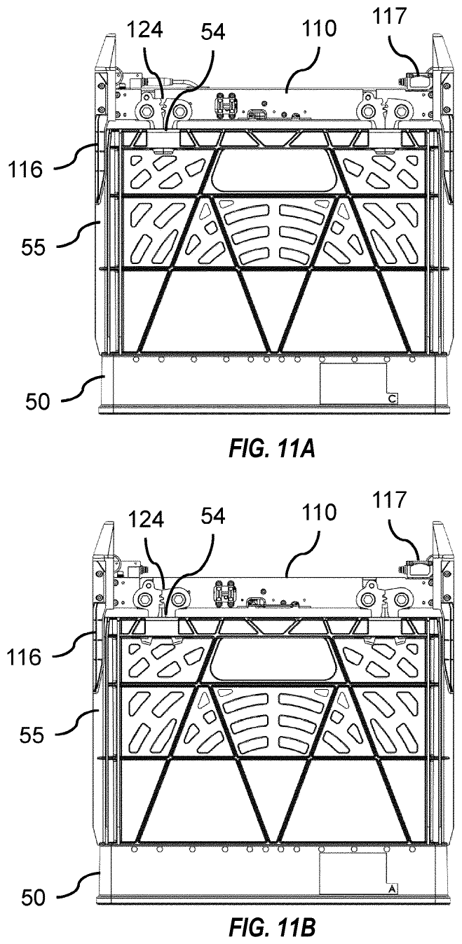

FIGS. 11A-11B are side views of the holding frame 110 and the storage container 50 showing how the grippers 124 interact with the apertures 54 to hold and release the storage container 50. Each aperture 54 is large enough in the horizontal direction to receive a respective gripper 124 when the gripper 124 is in the closed position but not when the gripper 124 is in the open position. FIG. 11A shows the holding frame 110 at a position above the storage container 50 in which the grippers 124 are in the closed position and have been received through the apertures 54 until the feet 128 are located below the underside of the rim 53. FIG. 11B shows the grippers 124 after they have been moved to the open position. In the open position, the feet 128 of the grippers 124 can engage with the underside of the rim 53 of the storage container 50. Subsequent raising of the holding frame 110 upwards by the lifting assembly 102 will therefore cause the storage container 50 to be lifted with the holding frame 110.

To hold and lift a storage container 50 using the container-handling system 100, the following operations can take place: the holding frame 110 is lowered by the lifting assembly 102 towards the top of the storage container 50 with the grippers 124 in the closed position until the grippers 124 are received in respective apertures 54 in the rim 53 and the feet of the grippers 124 are below the underside of the rim 53. The grippers 124 are then moved to the open position such that the feet 128 can engage the underside of the rim 53. The lifting assembly 102 then raises the holding frame 110, which causes the feet 28 to engage with the rim 53, which causes the storage container 50 to be raised with the holding frame 110. To lower and release a storage container 50, the above operation is carried out in reverse.

To facilitate alignment of the holding frame 110 with the storage container 50 so that the grippers 124 are received in the apertures 54 of the storage container 50, four locating members 116 are mounted at the four corners of the holding frame 110. The locating members 116 extend downwardly below the frame members 112. The storage container 50 further comprises cutouts 55 (or other forms of recess) at the corners of the storage container 50 for receiving the locating members 116. The locating members 116 are configured (e.g. tapered) such that the holding frame 110 can self-align with the storage container 50 when the holding frame 110 is being lowered towards the storage container 50.

To allow the container-handling system 100 to determine when a storage container 50 is close enough to the storage container 50 to open the grippers 124, the holding frame 110 may comprise one or more proximity sensors 117 mounted on the holding frame 110 configured to detect the vertical distance between the holding frame 110 and the top (i.e. the rim 53) of the storage container 50 as the holding frame 110 is being lowered by the lifting assembly 102. When the proximity sensor 117 detects that the top of the storage container 50 is at a particular predetermined distance from the holding frame, the lifting assembly 102 can stop lowering the holding frame 110 towards the storage container 50 and the holding assembly 120 can be activated to engage the storage container 50. Any suitable proximity sensor 117 known in the art may be used, e.g. an ultrasonic sensor.

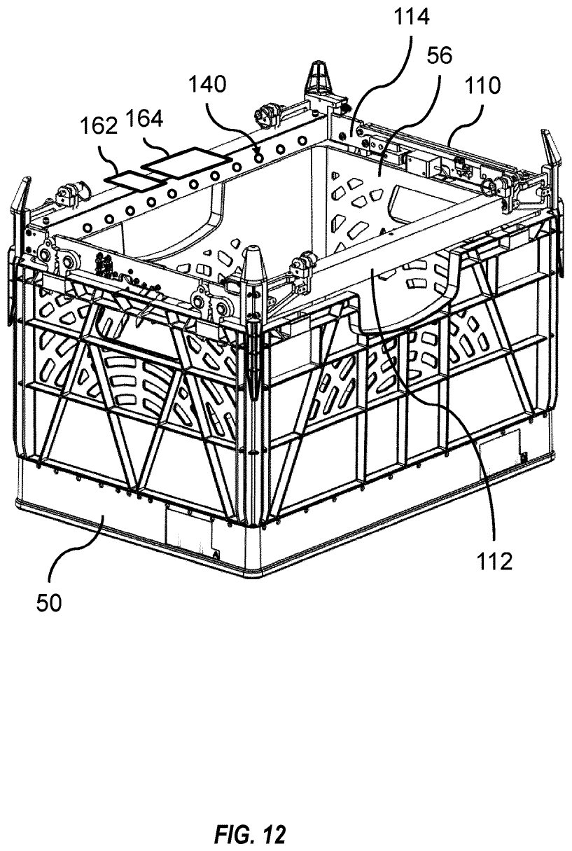

FIG. 12 is a perspective view showing holding frame 110 engaged with the storage container 50. The storage container 50 is occupying a holding region below the holding frame 110. The holding region is the region which the storage container 50 occupies when the holding assembly 120 is holding the storage container 50. Put another way, the holding assembly 120 is able to engage with the storage container 50 when the storage container 50 is in the holding region. The holding frame 110 (i.e. the arrangement of the holding members 112) in this example is sized to have approximately the same horizontal footprint as the storage container 50 such that upwards movement of the storage container 50 with respect to the holding frame 110 is physically limited by the frame members 112. In particular, the top of the storage container 50 can be located no higher than the bottom of the frame members 112 when being held by the holding frame 110. Thus, in this example, an approximate upper limit of the holding region may be considered to be a plane coincident with the bottom-most surface of the frame members 112.

When the storage container 50 is in the holding region, the frame opening 114 of the holding frame 110 is located above, and is in communication with, the top opening 56 of the storage container 50 such that objects could be placed into or removed from the storage container 50 via the top opening 56.

As mentioned above, the storage container 50 may be used to store objects. A situation may occur in which an overheight object protrudes above the top of the storage container 50. By providing the holding frame 110 with a frame opening 114, any overheight objects are likely to protrude through the frame opening 114 when the holding frame 110 is lowered towards the storage container 50, rather than hitting the holding frame 110, which could, for example, cause the holding frame 110 to be knocked out of alignment with the storage container 50.

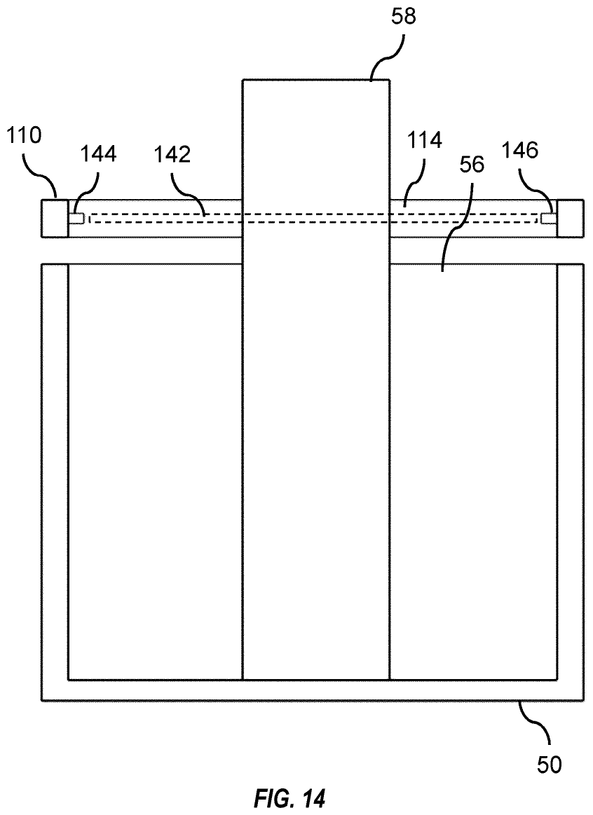

The holding frame 110 further comprises an overheight detection system 140 with object detection means for detecting when an object is present in an overheight region 142 (represented in later FIG. 14). The overheight region 142 is at a fixed location with respect to the holding frame 110 and is above the holding region, i.e. the overheight region 142 is above the top of the storage container 50 when the storage container 50 is being held by the holding assembly 120. Thus, the overheight detection system 140 can be used to detect when an object is protruding above the top of a storage container 50. The vertical distance between the overheight region 142 and the holding region may be chosen depending on how high an object can protrude above the top of the storage container 50 before it is considered a problem. The overheight region 142 may be just above the holding region to detect any overheight objects, or the overheight region 142 may be vertically spaced from the holding region to detect any overheight objects which protrude past a threshold height above the holding region.

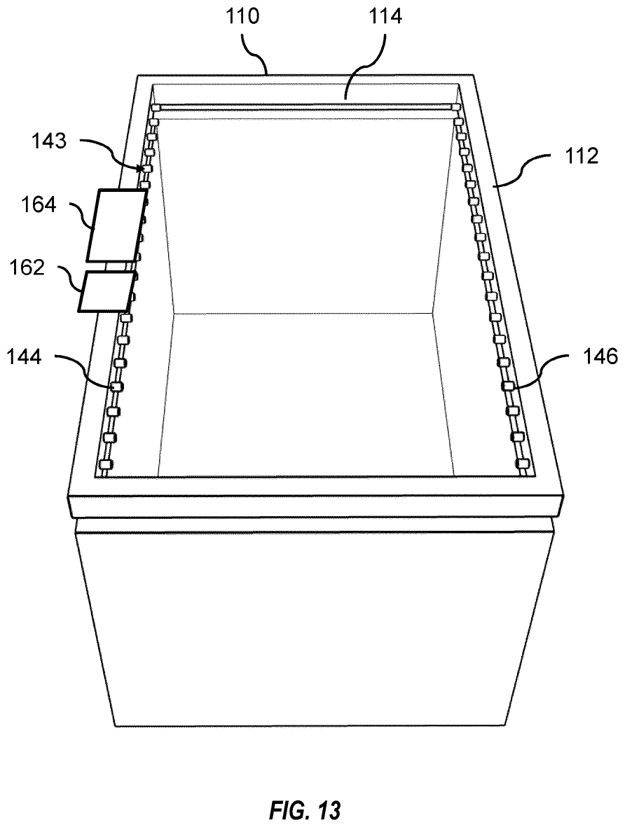

FIG. 13 is a simplified schematic diagram showing the holding frame 110 holding the storage container 50 in the holding region. In this example, the object detection means comprises a sensor assembly 143 comprising a plurality of infrared transmitters 144 mounted on a frame member 112 on one side of the frame opening 114 and a plurality of infrared receivers 146 mounted on an opposing frame member 112 on an opposing side of the frame opening 114. The infrared transmitters 144 are configured to emit infrared light across the frame opening 114 towards the infrared receivers 146 and the infrared receivers 146 are configured to detect infrared light emitted from the infrared transmitters 144.

The sensor assembly 143 defines an overheight region 142 (represented in later FIG. 14) extending between the transmitters 144 and receivers 146. In this example, the transmitters 144 and receivers 146 are arranged in a substantially horizontal plane within the frame opening 114 and therefore the overheight region 142 in this example is a substantially horizontal plane located within the frame opening 114.

FIG. 14 shows a schematic cross-sectional view of the holding frame 110 holding the storage container 50 in the holding region. Given that the frame opening 114 is located above storage container 50 and the sensor assembly 143 is arranged within the frame opening 114, the overheight region 142 is located directly above the top opening 56 of the storage container 50 when the storage container 50 is in the holding region. FIG. 14 also shows an overheight object 58 located within the storage container 50. The overheight object 58 protrudes above the top of the storage container 50 such that the overheight object 58 extends through the overheight region 142, between the infrared transmitters 144 and infrared receivers 146. This arrangement of the infrared transmitters 144 and infrared receivers 146 can therefore be used to detect the presence of an overheight object within the overheight region 142.

The overheight detection system 140 further comprises an object detection controller 162 mounted on the holding frame 110 (shown in FIG. 13) configured to control the object detection means. The infrared transmitters 144 and infrared receivers 146 are communicably coupled to the object detection controller 162 via electrical wires routed along the frame members 112. The object detection controller 162 is configured to switch each infrared transmitter 144 on and off. If an infrared receiver 146 detects an infrared signal, a signal is sent from the infrared receiver 146 to the object detection controller 162.

When the overheight detection system 140 is active, the object detection controller 162 switches on a first transmitter 144 and waits a period of time to receive a signal from each of the receivers 146 indicating that the infrared light from the first transmitter 144 was detected. If no object is present in the overheight region 142, each infrared receiver 146 should detect the infrared light emitted from the first infrared transmitter 144 and therefore the object detection controller 162 should receive a signal from each receiver 146. The object detection controller 162 then switches off the first transmitter 144 and switches on a second transmitter 144 and waits a period of time to receive a signal from each of the receivers 146 indicating that the infrared light from the second transmitter 144 was detected. This process then continues until all of the transmitters 144 have been switched on at least once.

If, while the overheight detection system 140 is active, an overheight object is within the overheight region 142, the light path between at least one transmitter 144 and at least one receiver 146 is blocked by the overheight object 58 and therefore at least one receiver 146 will not detect the signal from at least one of the transmitters 144. The object detection controller 162 will therefore not receive a signal from all of the receivers 146 when one of the transmitters 144 is switched on. The object detection controller 162 is configured to interpret this as meaning that an object 58 is present in the overheight region 142.

Depending on the number of transmitters 144 and receivers 146 and the space between them, it is possible that some of the receivers 146 will be too far away to detect the infrared light emitted from a particular transmitter 144, even if there are no objects in the overheight region. In this case, the object detection controller 162 can be configured to wait to receive a signal from a particular number of receivers 146 (i.e. one or more) after a transmitter 144 has been switched on, or a particular subset of the receivers 146 after a particular transmitter 144 has been switched on. For example, if the transmitters 144 and receivers 146 are arranged such that each transmitter 144 is in the line of sight of only three receivers 146, then the object detection controller 162 can be configured to wait to receive signals from three receivers 146 after switching on each transmitter

The number of transmitters 144 and receivers 146 and their arrangement on the holding frame 110 (e.g. the spacing between the transmitters 144 and the spacing between the receivers 146) can be chosen to reduce the number and size of any blind spots in the overheight region 142.

The container-handling system 100 further comprises a frame controller 164 mounted on the holding frame 110 (shown in FIG. 13). The frame controller 164 is communicably coupled to the object detection controller 162 in order to activate the sensor assembly 143 and receive feedback from the object detection controller 162 relating to the outcome of the object detection. The frame controller 164 is further configured to control the holding assembly 120, i.e. control the actuators 130 to open and close the grippers 124, and receive feedback from the proximity sensor 117.

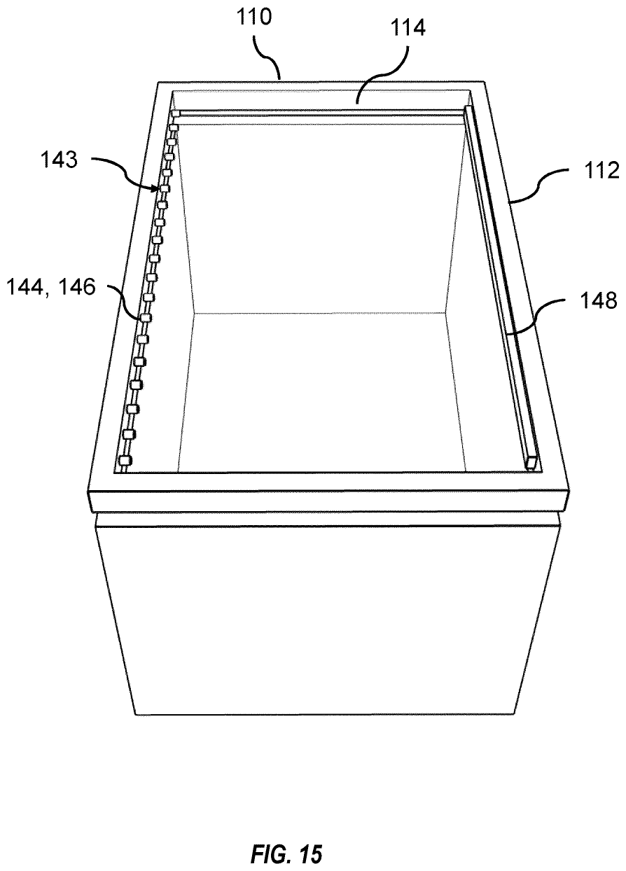

The above-described arrangement of infrared transmitters 144 and receivers 146 is an example of how photoelectric sensors arranged in a through-beam arrangement can be used to detect the presence of an object in the overheight region 142. The photoelectric sensors may also be in a retroreflective arrangement instead of a through-beam arrangement. FIG. 15 schematically shows an example in which a plurality of transmitters 144 and receivers 146 are mounted a frame member 112 on the one side of the frame opening 114. The frame member 112 on the opposite side of the frame opening 114 acts as a reflector 148, or a separate reflector 148 may be mounted on the frame member 112. In this example, the sensor assembly 143 is operated in a similar way to the above-described through-beam arrangement, except that the signals emitted by the transmitters 144 are reflected by the reflector 148 before being received by the receivers 146. If an object blocks the signal between at least one of the transmitters 144 and the reflector 148, or between the reflector 148 and at least one of the receivers 146, then at least one of the receivers 146 will not detect a signal, which the object detection controller 162 can use to determine that an object is present in the overheight region 142.

The sensor assembly 143 is not limited to comprising infrared photoelectric sensors. Other types of photoelectric sensors may be used, e.g. visible red or laser. The sensor assembly 143 is also not limited to comprising photoelectric sensors. Other types of object detection sensors known in the art may be used, e.g. ultrasonic sensors, which may be arranged in a through-beam or retroreflective arrangement as described above.

The sensor assembly 143 does not need to be located within the frame opening 114 and therefore the overheight region 142 does not need to be located within the frame opening 114. Instead, the sensor assembly 143 may be mounted above or below the frame opening 114 such that the overheight region 142 is above or below the frame opening 114.

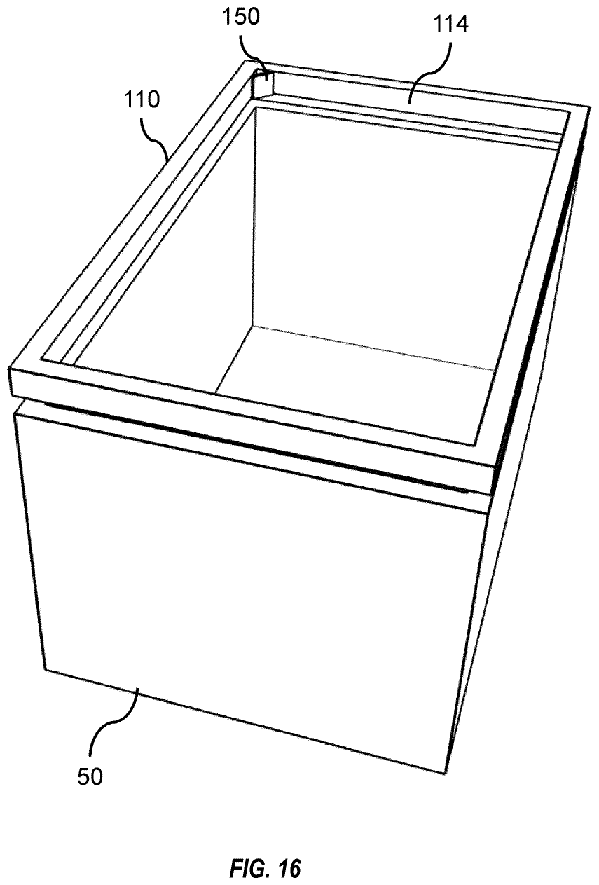

FIG. 16 is a schematic perspective view of another example of the container-handling system 100 in which the object detection means comprises a camera 150 mounted on the holding frame 110 and one or more processors configured to analyze the images captured by the camera 150. The one or more processors may be part of the object detection controller 162. When the overheight detection system 140 is active, the camera 150 is configured to capture at least one image that contains the overheight region 142 and the one or more processors are configured to analyze the captured image to determine whether or not an object is present within the overheight region 142. As shown in FIG. 16, the camera 150 may be mounted on the holding frame 110 in one corner of the frame opening 114 and point in an approximately horizontal direction towards the opposite corner of the frame opening 114. The viewpoint of the camera 150 may be fixed and a region of pixels of each image captured by the camera 150 may be designated as the overheight region 142. The captured images can then be analyzed by the processor using known image analysis techniques to determine whether or not an object is present in the overheight region 142. For example, a machine learning algorithm (e.g. a convolutional neural network) trained to detect the presence of an object in the overheight region may be used. The machine learning algorithm may have been trained on images taken by the camera 150 which have been classified into images containing an object in the overheight region and images not containing an object in the overheight region.

The object detection system 140 may further comprise a light source (e.g. one or more LEDs) mounted on the holding frame 110 that provides light when the camera 150 captures an image so that there is greater contrast between the overheight region 142 and an object within the overheight region 142 in the capture image. This may allow the processor to analyze the captured image and detect objects in the overheight region 142 more effectively. For example, a white light source may be used such that, in the captured image, empty areas of the overheight region appear white and any objects within the overheight region appear dark. The processor may then calculate the proportion of dark pixels to white pixels in the overheight region of the captured image, and if the proportion of dark pixels is above a threshold, the processor determines that an object is present in the overheight region.

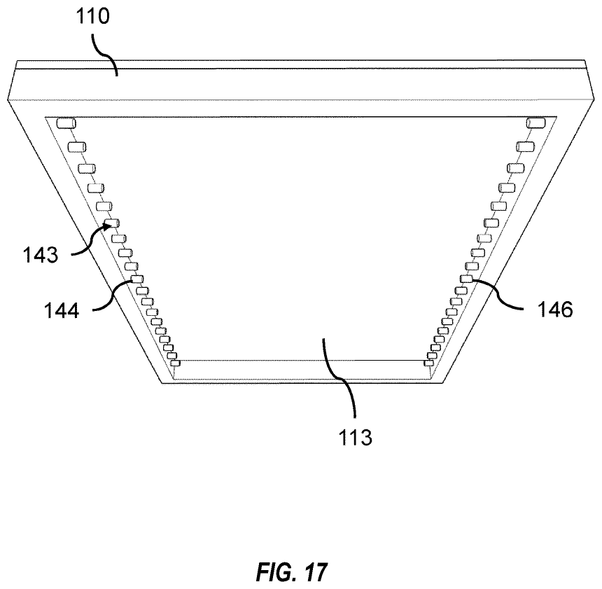

FIG. 17 is a schematic bottom perspective view of an alternative holding frame 110 which does not have a frame opening 114 and instead comprises a substantially horizontal sheet 113 mounted between the frame members 112. In this example, the horizontal sheet 113 covers the top of the holding frame 110 and the frame members 112 extend downwards from the horizontal sheet 113 to define a recess 115 on the bottom side of the holding frame 110 which provides a headroom for overheight objects above the holding region. In this illustrated example, the overheight detection system 140 is configured to detect the presence of an object within an overheight region 142 located within the recess 115 using the sensor assembly 143 shown in FIG. 13, i.e. transmitters 144 and receivers 146 mounted on opposing lateral sides of the recess 115; however, other object detection means such as the sensor assembly 143 shown in FIG. 15 and the camera shown in FIG. 16 may also be used.

The holding frame 110 shown in FIG. 17 but without the transmitters 144 and receivers 146 also represents another example in which the object detection means can comprise a mechanical force sensor. In particular, the force applied against the underside of the horizontal sheet 113 from an overheight object when the holding frame 110 is being lowered towards a storage container 50 can be used to determine the presence of the overheight object. In this case, the overheight region 142 is defined by the horizontal sheet 113, i.e. the plane in which the horizontal sheet 113 lies, or just below the plane in which the horizontal sheet 113 lies. For example, the horizontal sheet 113 may be an elastomeric material under tension and an increase in the tension, as measured by a tension sensor, can be used to determine the presence of an object in the overheight region 142. Alternatively, the horizontal sheet 113 may be part of a load cell which is configured to detect the load applied to the horizontal sheet 113. An increase in the detected load (e.g. above a particular threshold) can be used to determine the presence of an object in the overheight region 142. Although FIG. 17 illustrates the horizontal sheet 113 as forming the top surface of the holding frame 110, the horizontal sheet 113 could be located at other vertical positions with respect to the frame members 112. If the holding frame 110 has a frame opening 114, then the horizontal sheet 113 could be mounted within the frame opening 114.

Referring back to FIG. 7, the container-handling system 100 further comprises an electrical cable 118 to provide power to the various electrical and electronic components on the holding frame 110 (e.g. the frame controller 164, the holding assembly 120 and the overheight detection system 140). In this illustrated example, one end of the electrical cable 118 is mounted on a spool that is mounted to a portion of the lifting assembly 102 such that the electrical cable 118 is wound and unwound as the lifting assembly 102 winds and unwinds the tethers 104. The other end of the electrical cable 118 is mounted to the holding frame 110, although FIG. 7 shows the electrical cable 118 disconnected from the holding frame 110. The electrical cable 118 electrically couples a power source of the bot 25 (e.g. a battery) to the electrical and electronic components mounted on the holding frame 110. The electrical cable 118 also allows for data transfer (e.g. between the frame controller 164 and a bot controller 166 in or on the body 27 of the bot 25). The electrical cable 118 may be any suitable electrical cable for transmitting power and/or data, e.g. a flexible flat cable (FFC).

The storage and retrieval system may be used to store products that can be ordered by customers. The products are stored in the storage containers 50 within the storage structure 1 and the identity and location of each product within the storage structure 1 is stored in a database. The location of a product includes the grid cell 14 under which the storage container 50 containing the product is located and the vertical position of the storage container 50 underneath the grid cell 14.

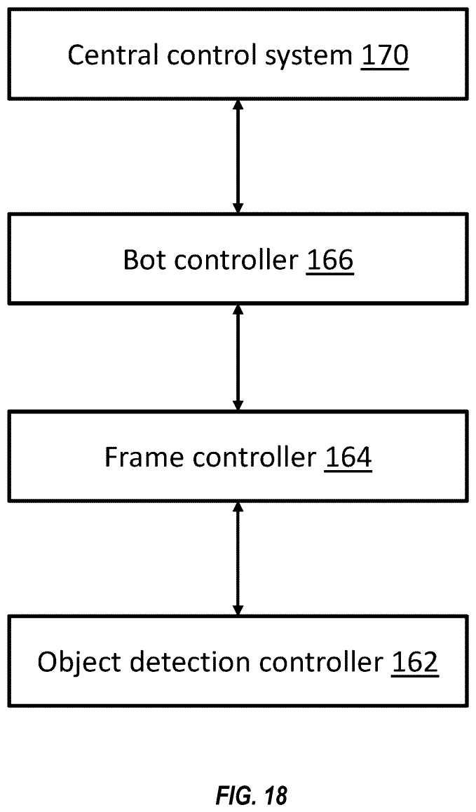

FIG. 18 is a block diagram showing an example control system of the storage and retrieval system. The positions of the bots 25 on the track structure 13, and their routes between positions on the track structure 13, are controlled by a central control system 170 comprising one or more controllers which are in wireless communication with each bot 25 on the track structure 13 using wireless transmitters and receivers and a suitable wireless communication technology such as 4G, 5G, Wi-Fi, etc. The one or more controllers of the central control system 170 receive data relating to which products are entering the storage and retrieval system and which products have been ordered by customers and uses this data to calculate routes for the bots 25 between target grid cells 14 to pick up and drop off particular storage containers 50 at particular locations. The one or more controllers of the central control system 170 command the bots 25 to move to target grid cells 14 via the calculated routes and pick up or drop off storage containers 50 at the target grid cells 14.

The bot 25 comprises a bot controller 166 configured to control functions of the bot 25, such as operation of the driving assembly to move the bot 25 in a particular direction and for a particular distance, and operation of the lifting assembly 102 to lower and raise the holding frame 110. As mentioned above, the bot controller 166 is in wireless communication with the central control system 170 via a wireless transmitter and receiver mounted on the bot 25. The bot controller 166 is configured to receive commands from the central control system 170 (e.g. move to a particular grid cell 14 via a particular route and pick up or drop off a storage container 50) and send status updates to the central control system 170 (e.g. confirming the position of the bot 25 on the track structure 13 and the status of the lifting assembly 102).

As mentioned above, the holding frame 110 comprises a frame controller 164 configured to control functions of the holding frame 110 including operation of the holding assembly 120. The bot controller 166 and the frame controller 164 are communicably coupled via the electrical cable 118 such that the bot controller 166 and the frame controller 164 can send signals between each other. For example, the bot controller 166 may command the frame controller 164 to activate the holding assembly 120 and the frame controller 164 may confirm to the bot controller 166 that the holding assembly 120 has been activated.

As also mentioned above, the holding frame 110 further comprises an object detection controller 162 communicable coupled to the frame controller 164. The object detection controller 162 is configured to control the object detection means, determine the presence of an object in the overheight region 142 from the objection detection means and communicate the result to the frame controller 164.

During operation of the storage and retrieval system, the central control system 170 may command a bot 25 to follow a calculated route to a target grid cell 14 and pick up a target storage container 50 below the target grid cell 14. The bot controller 166 receives this command and controls the driving assembly to move the bot 25 to the target grid cell 14. The bot controller 166 then controls the lifting assembly 102 to lower the holding frame 110 from its home position (in or above the container-receiving space 45) towards the target storage container 50. Once the proximity sensor 117 detects that the target storage container 50 is in the holding region, the frame controller 164 sends a signal to the bot controller 166, which controls the lifting assembly 102 to stop lowering the holding frame 110. While the holding frame 110 is being lowered, the frame controller 164 can activate the overheight detection system 140 via the object detection controller 162 to determine whether or not an object is present in the overheight region 142.

If no object is detected within the overheight region 142 during the descent of the holding frame 110, then the holding frame 110 reaches the top of the target storage container 50 and the frame controller 164 activates the holding assembly 120 to engage and hold the storage container 50. The frame controller 164 then communicates to the bot controller 166 that the holding assembly 120 is engaged and the bot controller 166 controls the lifting assembly 102 to raise the holding assembly 120 back to its home position such that the target storage container 50 is received into the container-receiving space 45 of the bot 25.

If, on the other hand, object detection controller 162 determines that an object is present in the overheight region 142 during the descent of the holding frame 110, the frame controller 164 will not activate the holding assembly 120 and will communicate the presence of the overheight object to the bot controller 166, which controls the lifting assembly 102 to halt descent of the holding frame 110 and raise the holding frame 110 back to its home position. Once the holding frame 110 has returned to the home position, the overheight detection system can be reset so that the frame controller 164 can potentially activate the holding assembly 120 the next time the holding frame 110 is lowered to pick up a storage container 50.

Alternatively, the overheight detection system 140 may only be activated once the holding frame 110 has been lowered to a position above the storage container 50 at which the holding assembly 120 can engage with the storage container 50 (i.e. when the storage container 50 is in the holding region). If the object detection means detects an object in the overheight region 142, then the holding assembly 120 is not activated and the lifting assembly 102 raises the holding frame 110 back to its home position. If the object detection means does not detect an object in the overheight region 142, then the holding assembly 120 is activated to engage and hold the storage container 50 and the lifting assembly 102 raises the holding frame 110 back to its home position such that the storage container 50 is received into the container-receiving space 45.

Thus, the container-handling system 100 comprising the overheight detection system 140 can be used to avoid or minimize the risk of any issues associated with the holding frame 110 attempting to engage with a storage container 50 containing an overheight object, any issues associated with raising a storage container 50 containing an overheight object into the container-receiving space 45 of the bot 25, and any issues associated with that storage container 50 entering other areas of the storage and retrieval system.

In addition, the bot controller 166 may send a signal to the central control system 170 to indicate that an overheight object was detected while the bot 25 was at the target grid cell 14. In response, the central control system 170 may remove that target grid cell 14 from a list of available grid cells 14 of the storage and retrieval system so that no bots 25 are commanded to pick up a storage container 50 from that target grid cell 14. The central control system 170 may also trigger a process to deal with the overheight object. For example, a special type of bot for dealing with overheight objects may be commanded to move to the target grid cell 14 and retrieve the storage container 50 containing the overheight object. The special bot may comprise a taller container-receiving space 45 that can accommodate a storage container 50 with an overheight object so that the special bot can pick up the storage container 50 containing the overheight object and drop it off at a location where the overheight object can be removed or repositioned within the storage container 50.

The overheight detection system 140 can also be used to determine the protruding height of an overheight object, i.e. the vertical height of the portion of the overheight object that is protruding above the top of a storage container 50. For example, the vertical distance travelled by the holding frame 110 during an overheight time period could be determined, wherein the overheight time period is the time period between the point at which the object detection means first detects an object in the overheight region 142 and the point at which the holding frame 110 is in a position for engaging the storage container 50 (i.e. the point at which the storage container 50 is in the holding region). The vertical distance travelled by the holding frame 110 during the overheight time period will approximately correspond to the protruding height of the overheight object. The vertical distance travelled by the holding frame 110 during the overheight time period could be determined in a number of different ways. For example, the rotation of a component of the lifting assembly that rotates as the tethers 104 unwind (e.g. a motor, a spool or a shaft) could be measured using a rotary encoder and the measurements from the rotary encoder could be translated into the length of tether 104 that was unwound from the spools 106 during the overheight time period, which corresponds to the vertical distance travelled by the holding frame 110. Alternatively, if the holding frame 110 is lowered (or is assumed to be lowered) at a constant or predetermined velocity, then the vertical distance travelled by the holding frame 110 during the overheight time period could be determined using a predetermined value for the velocity of the holding frame 110. The determination of the protruding height of an overheight object could be carried out by one or more of the bot controller 166, the frame controller 164 and the object detection controller 162.

By determining the protruding height of an overheight object, the overheight detection system 140 can determine how to proceed based on the protruding height of an overheight object, rather than just the mere presence of an overheight object. For example, if the protruding height is less than a protruding threshold that is unlikely to cause any negative issues, then the holding assembly 120 and lifting assembly 102 may be activated as usual to hold and lift the storage container. In this case, the presence of an overheight object in the storage container 50 may just be recorded in a log for reference. However, if the protruding height is greater than or equal to a protruding threshold, then the holding frame 110 may be raised back to the container-receiving space 45 without activating the holding assembly 120 so that the storage container 50 is not picked up.

The invention is not limited to the precise forms described above and various modifications and variations will be apparent to the skilled person without departing from the scope of the invention as defined in the accompanying claims.

For example, instead of holding frame 110 being formed from four separate elongate frame members 112 joined together, the holding frame 110 may be formed from fewer separate frame members 112 (e.g. two L-shaped frame members), or a single frame member (e.g. a unibody).

Furthermore, the invention is not limited to the particular holding assembly 120 described above and any form of holding assembly 120 for releasably holding a storage container 50 from above may be used. In the case where the holding assembly 120 comprises grippers, the grippers may be moveable between an engaged position for engaging a storage container 50 and a disengaged position for disengaging a storage container 50 using any suitable arrangement of one or more linear or rotational actuators and linkages.

Furthermore, instead of providing a proximity sensor 117 on the holding frame 110 to detect when the holding frame 110 has been lowered far enough to engage a target storage container 50, the lifting assembly 102 can lower the holding frame 110 by a predetermined distance based on the known vertical position of the target storage containers 50 within the storage structure 1.

Furthermore, the above description of the bot controller 166, the frame controller 164 and the object detection controller 162 and their associated functions is just one example of how the control system of the bot 25 and the container-handling system 100 may be arranged. In the above-described example, the functions of the container-handling system 100 (e.g. operating the lifting assembly 102, operating the holding assembly 120 and operating the object detection means) are distributed between the bot controller 166, the frame controller 164 and the object detection controller 162. In other examples, the functions of at least two of the bot controller 166, the frame controller 164 and the object detection controller 162 could be combined. For example, all the functions of the container-handling system 100 may be carried out by a single controller, e.g. the bot controller 166, or the functions of the object detection controller 162 could incorporated into the frame controller 164. The functions of the container-handling system 100 may also be distributed among the bot controller 166, the frame controller 164, and the object detection controller in a different way to that described above.

What is claimed is:

1. A container-handling system comprising:
a holding frame;
a holding assembly mounted on the holding frame, wherein the holding assembly is configured to releasably hold a storage container in a holding region with respect to the holding frame; and
an overheight detection system comprising object detection means mounted on the holding frame, wherein the object detection means is configured to detect an object in an overheight region, wherein the overheight region is above the holding region.

2. The container-handling system according to claim 1, wherein the overheight region is a substantially horizontal plane, and wherein the object detection means is configured to detect an object between at least two points lying in a horizontal plane.

3. The container-handling system according to claim 1, wherein the holding assembly is configured to releasably hold a storage container from above.

4. The container-handling system according to claim 1, wherein the holding frame comprises a frame opening extending vertically through the holding frame.

5. The container-handling system according to claim 4, wherein at least a portion of the overheight region is located within or above the frame opening.

6. The container-handling system according to claim 4, wherein at least a portion of the object detection means is mounted within or above the frame opening.

7. The container-handling system according to claim 1, wherein the object detection means comprises a sensor assembly arranged on opposing lateral sides of the overheight region.

8. The container-handling system according to claim 7, wherein;
the sensor assembly comprises at least one transmitter and at least one receiver mounted on the holding frame on opposing lateral sides of the overheight region, wherein the at least one transmitter is configured to emit a signal towards the at least one receiver and the at least one receiver is configured to detect the signal from the at least one transmitter; and
the overheight detection system further comprises a controller communicably coupled to the at least one transmitter and the at least one receiver, wherein the controller is configured to determine that an object is in the overheight region when the signal between the at least one transmitter and the at least one receiver is interrupted.

9. The container-handling system according to claim 7, wherein;
the sensor assembly comprises at least one transmitter and at least one receiver mounted on the holding frame on the same lateral side of the overheight region, and at least one reflector at an opposing lateral side of the overheight region, wherein the at least one transmitter is configured to emit a signal towards the at least one reflector and the at least one receiver is configured to detect the signal from the at least one transmitter after being reflected by the at least one reflector; and
the overheight detection system further comprises a controller communicably coupled to the at least one transmitter and the at least one receiver, wherein the controller is configured to determine that an object is in the overheight region when the signal between the at least one transmitter and the at least one receiver via the at least one reflector is interrupted.

10. The container-handling system according to claim 1, wherein the object detection means comprises:
a camera mounted on the holding frame, wherein the camera is configured to capture an image containing the overheight region; and
one or more processors configured to analyze the image and detect an object within the overheight region.

11. The container-handling system according to claim 1, further comprising a lifting assembly configured to lower and raise the holding frame.

12. The container-handling system according to claim 1, wherein the object detection means comprises a substantially horizontal sheet defining the overheight region and the object detection means is configured to detect a force being applied to the substantially horizontal sheet to detect an object in the overheight region.

13. The container-handling system according to claim 1, further comprising a control system comprising one or more controllers configured to control operation of the holding assembly based on a detection outcome by the object detection means.

14. The container-handling system according to claim 13, wherein the control system is configured such that the holding assembly is not activated if the object detection means detects an object in the overheight region.

15. The container-handling system according to claim 14, wherein the control system is configured to control a lifting assembly to raise the holding frame without activating the holding assembly if the object detection means detects an object in the overheight region.

16. The container-handling system according to claim 13, wherein the control system is configured to determine a height of an object protruding above a storage container based on a vertical distance descended by the holding frame during a time period between a point at which an object is first detected in the overheight region and a point at which a storage container is in the holding region.

17. The container-handling system according to claim 1, wherein:
the container-handling system further comprises a load handling device for lifting and moving storage containers arranged in stacks in a storage structure comprising a track structure above the stacks of storage containers, the load handling device comprising:
a body; and
a driving assembly configured to move the body on the track structure, and
the container-handling system further comprises a lifting assembly configured to lower and raise the holding frame of the container-handling system relative to the body of the load handling device.

18. The load handling device according to claim 17, further comprising a container-receiving space configured to accommodate a storage container held by the holding frame, wherein the lifting assembly is configured to raise and lower the holding frame into and out of the container-receiving space respectively.

19. A storage and retrieval system, comprising:
a storage structure, comprising:
a plurality of stacks of storage containers, each storage container having a top opening through which objects can be placed into the storage container; and
a track structure arranged above the plurality of stacks of storage containers and configured to allow access to each stack from above, and
the storage and retrieval system further comprises at least one load handling device, the at least one load handling device comprising:
the storage structure, the storage structure comprising a track structure above the stacks of storage containers;
a body;
a driving assembly configured to move the body on the track structure; and
a container-handling system, comprising:
a holding frame;
a holding assembly mounted on the holding frame, wherein the holding assembly is configured to releasably hold a storage container in a holding region with respect to the holding frame; and
an overheight detection system comprising object detection means mounted on the holding frame, wherein the object detection means is configured to detect an object in an overheight region, wherein the overheight region is above the holding region, and
a lifting assembly configured to lower and raise the holding frame relative to the body,
wherein the container-handling system is configured to pick up and drop off storage containers from and onto the stacks of storage containers.

20. A method of using a load handling device for lifting and moving storage containers arranged in stacks in a storage structure, wherein:
the load handling device comprises:
the storage structure, the storage structure comprising a track structure above the stacks of storage containers;
a body;
a driving assembly configured to move the body on the track structure; and
a container-handling system, the container-handling system comprising:
a holding frame;
a holding assembly mounted on the holding frame, wherein the holding assembly is configured to releasably hold a storage container in a holding region with respect to the holding frame;
an overheight detection system comprising object detection means mounted on the holding frame, wherein the object detection means is configured to detect an object in an overheight region, wherein the overheight region is above the holding region; and
a lifting assembly configured to lower and raise the holding frame relative to the body, and
the method comprises:
lowering the holding frame towards a storage container;
detecting whether or not an object is present within the overheight region;
if an object is detected, raising the holding frame away from the storage container without activating the holding assembly; and
if an object is not detected, activating the holding assembly to hold the storage container and then raising the holding frame.
